(19) United States
(12) Patent Application Publication
(10) Pub. No.: US 2005/0204574 A1
(43) Pub. Date: Sep. 22, 2005

(54) Multi-hole punch paper alignment and holder device

(76) Inventor: Arthur W. Bigelow JR., Irvine, CA (US)

Correspondence Address: Mr. & Mrs. Bigelow, 15482 Lorraine Way, Irvine, CA, 92604, US

(21) Appl. No.: 10/635,202

(22) Filed: Aug. 6, 2003

Related U.S. Application Data
(60) Provisional application No. 60/489,890, filed on Jul. 23, 2003.

(51) Int. Cl. G01D 21/00

(52) U.S. Cl. 33/623

(57) ABSTRACT

A multi-hole punched paper alignment and holder device for temporarily holding multiple hole punched paper. The multi-hole punched paper alignment and holder device includes a base and two poles projection upwardly from the base. The poles are spaced from each other by a distance substantially the same as the axial distance between two adjacent holes punched in the paper, and the diameters of the poles are slightly smaller than the diameter of the holes. Therefore, by axially aligning the hole of the paper over the poles, the paper can be slide downwardly along the length of the poles and be aligned and temporarily held in place by the alignment and holder device.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates in general to a multi-hole paper alignment and holder device and, more particularly, to a two-hole paper punch alignment and holder device.

Loose sheets of paper are commonly kept together by providing the papers with multiple and preferably two holes/perforations and maintaining them in a file folder having either a binder ring or typically a prong paper fastener. It is typical that some sheets of paper have to be temporarily removed from the file folder for making extra copies or adding other sheets of paper thereto. When the number of removed sheets of paper is large, misalignment of the punched holes in the paper is unavoidable, and it is inconvenient and time consuming to re-file the removed sheets of paper back into the file folder.

### BRIEF SUMMARY OF THE INVENTION

The present invention provides a multi-hole punched paper alignment and holder device for temporarily holding paper punched with conventional two holes spacing. The hole punched paper alignment and holder includes a base and two elongate alignment poles extending upwardly from the base. The poles are spaced from each other by a distance substantially equal to the distance between the two or more holes punched through the paper. The diameter of the poles are preferably slightly smaller than the diameter of the holes. Therefore, by axially aligning the holes of the punched paper over the poles, the paper can be aligned and temporarily held by the alignment and holder device by sliding the paper stack over the poles.

The present invention further provides a hole punched paper alignment and holder device for temporarily holding papers each punched with two or more holes spaced from each other by variable distances. The alignment and holder device comprises a base, a slot mounted to the base, a pair of locking members slidably attached to the slot, and a pair of poles extending vertically upward from the locking members. Therefore, the poles are movable by sliding the locking members along the slot. The alignment and holder device further comprises a pair of locking surfaces formed on one side of the slot and a corresponding surface of each locking member. In one embodiment, the locking surfaces comprise a serrated edge formed on the slot and a serrated surface formed in the locking member. Each locking member may further comprise an engaging/disengaging member to selectively engage/disengage the locking surfaces. The engaging/disengaging members can be controlled by manual, press-release buttons, for example, to thereby accommodate both conventional two-hole punched and three-hole punched paper.

### BRIEF DESCRIPTION OF THE DRAWINGS

These as well as other features of the present invention will become more apparent upon reference to the drawings wherein:

FIG. 1 shows the application of the multi-hole punched paper alignment and holder device of the present invention to temporarily align and hold stacked sheets of paper removed from a file folder;

FIG. 2 shows a side view of the multi-hole punched paper alignment and holder device;

FIG. 3 shows a top view of the multi-hole punched paper alignment and holder device; and

FIG. 4 shows a multi-hole punched paper alignment and holder device adapted for holding papers punched with two holes spaced from each other by variable distances.

### DETAILED DESCRIPTION OF THE INVENTION

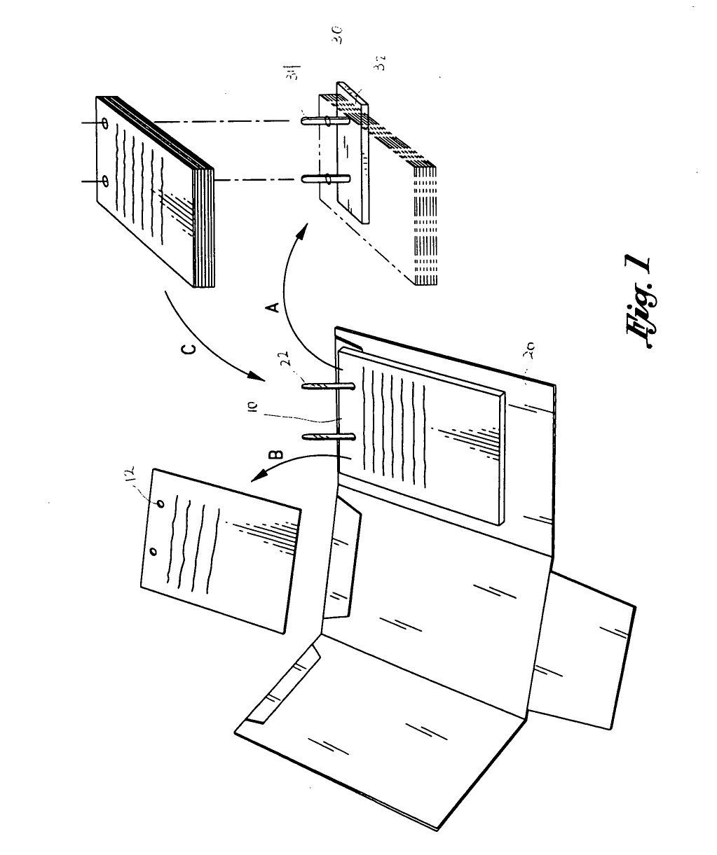

Referring to FIG. 1, the present invention provides a multi-hole punched paper alignment and holder device for temporarily aligning and holding two or more hole punched paper, particularly for punched paper temporarily removed from a file folder. As is well known, a stack of sheets of paper 10 that has been punched with conventional two holes 12 is maintained in alignment by a conventional prong paper fattener mounted in a file folder 20. When some of the sheets of paper 10 are removed from the file folder 20, to avoid misaligning the holes 12 of the removed sheets of paper 10, or disturbing the order of the removed sheets of paper 10, the multi-hole punched paper alignment and holder device 30 of the present invention is utilized.

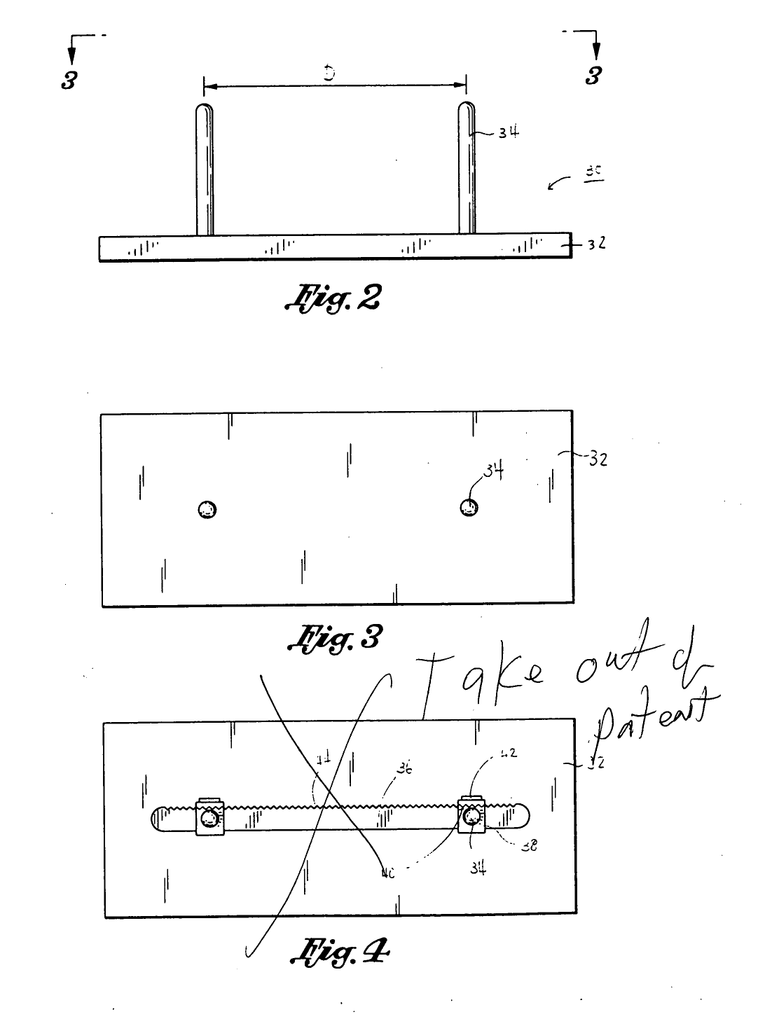

FIGS. 1, 2 and 3 show the perspective view, the side view and the top view of the hole punched paper alignment and holder device 30. As shown in FIGS. 1-3, the hole paper alignment and holder device comprises a base 32 and two vertically extending poles. The distance between the two poles 34 is substantially equal to the distance between the holes 12 punched through the sheets of paper 10. In this embodiment, the distance between the poles 34 is about 2.75 inches, and the length of the base 30 is about 4.75 inches. However, it will be appreciated that the distance D can be variable according to the distance between the holes 12, and the length of the base 30 is variable according to specific requirement. The diameter of the poles 34 is preferably slightly less than that of the holes 12 to allow the sheets of paper 10 to easily slide over the poles 34.

To employ the multi-hole paper alignment and holder device to align and hold paper punched with two or more holes spaced from each other with variable distances, the present invention further provides another embodiment as show in FIG. 4. As shown, the second embodiment is similar to the first embodiment. The multi-hole punched paper alignment and holder device includes a base 32 and two poles 34 projecting upwardly from the base 32. However, in this embodiment, the poles 34 are not directly mounted to the base 32. Instead, the multi-hole punched paper alignment and holder device includes a slot 36 and two slidable locking members 38. Each of the slidable locking members 38 carries one of the poles 34, such that when the slidable locking member 38 is slid along the length of the slot 36, the axial spacing of the poles 34 is adjusted. As shown, at least one elongate side 44 of the slot 36 is serrated, and each of the locking members 38 comprises a corresponding serrated surface 40 to selectively engage the serration formed on the slot 36. Each of the locking members 38 further comprises an engaging/disengaging member 42. When the engaging/disengaging members 42 are manually pressed towards the slot 36, the serrated surface 40 is disengaged from the serrated side 44, so that the locking members 38 can be slid along the length of the slot 36. In contrast, when the engaging/disengaging members 42 are released, the serrated surfaces 40 are engaged with the serrated side 44; and consequently, the slidable locking members 38 are locked, and the positions of the poles 34 are fixed within the slot. Therefore, by sliding the locking members 38, the poles 34 are movable along the slot 36; and consequently, the distance between the poles 34 are adjusted for aligning and holding paper punched with two holes spaced with each other by different distance D. In this regard it will be recognized that this embodiment of the present invention facilitates alignment of conventional three-hole punched ring binder paper by allowing two adjacent holes of such paper to extend over the two poles of the device.

This disclosure provides exemplary embodiments of the present invention. The scope of the present invention is not limited by these exemplary embodiments. Numerous variations, whether explicitly provided for by the specification or implied by the specification, such as variations in structure, dimension, number of poles, type of material and manufacturing process may be implemented by one of skill in the art in view of this disclosure.

1. A multi-hole punched alignment and holder device for temporarily holding paper punched with two or more holes spaced from each other by a distance, comprising:
a base; and
two poles projecting from the base, wherein the two poles are spaced from each other by a distance substantially the same as the distance between two holes formed in the paper.

2. The alignment and holder device of claim 1, wherein the poles are located adjacent the center of the base.

3. The alignment and holder device of claim 1, wherein the diameters of the poles is less than the diameter of the holes.

4. A multi-hole punched paper alignment and holder device for temporarily holding paper punched with at least two holes, comprising:
a base;
a slot mounted to the base;
a pair of locking members, slidably attached to the slot; and
a pair of poles, projecting upright from the locking members, the poles being manually movable by sliding the locking members within the slot.

5. The alignment and holder device of claim 4, further comprising a pair of locking surfaces formed on one side of the slot and a corresponding surface of each slidable locking member.

6. The alignment and holder device of claim 5 wherein each slidable locking member further comprises an engaging/disengaging member to engage/disengage the locking surfaces.

7. The alignment and holder device of claim 6, wherein the engaging/disengaging members include manually press-release buttons.

8. The alignment and holder device of claim 4, wherein the slot comprises at least one serrated side, and each slidable locking member comprises a serrated surface to be engaged with the serrated side of the slot.
